(19) United States
(12) Patent Application Publication
(10) Pub. No.: US 2026/0014848 A1
(43) Pub. Date: Jan. 15, 2026

(54) TRANSMISSION ASSEMBLY AND AGRICULTURAL TRACTIVE UNIT

(71) Applicant: DEERE & COMPANY, MOLINE, IL (US)

(72) Inventor: KRUTIN RAJANI, MANNHEIM (DE)

(21) Appl. No.: 19/225,389

(22) Filed: Jun. 2, 2025

(30) Foreign Application Priority Data
Jul. 12, 2024 (EP) 24188296.8

(51) Int. Cl. B60K 6/365; A01B 76/00; B60K 6/12; B60K 6/387; B60K 6/547; B60K 17/28

(52) U.S. Cl. CPC B60K 6/365; A01B 76/00; B60K 6/12; B60K 6/387; B60K 6/547; B60K 17/28; B60Y 2200/221; B60Y 2200/92

(57) ABSTRACT

A transmission assembly for a drivetrain of an agricultural tractive unit includes an input shaft, a first output shaft for a traction drive, a second output shaft for a PTO drive, and a first energy machine operatively connected to the input shaft via a branching stage, such that the power of the first energy machine is able to be transmitted to at least one coupled energy machine operatively connectable selectively to one or more of the first output shaft or the second output shaft via one or more clutches of a gear shift stage.

### CROSS-REFERENCE TO RELATED APPLICATIONS

This application claims priority to European Patent Application No. 24188296.8, filed Jul. 12, 2024, which is hereby incorporated by reference.

### FIELD OF THE DISCLOSURE

The disclosure relates to a transmission assembly and an agricultural tractive unit.

### BACKGROUND

A transmission system includes an input shaft, a shiftable transmission, and an output shaft. A transmission system can use a manual transmission or a continuously variable transmission as components. Manual transmissions use power-shiftable clutches which interconnect different meshing gearwheel stages. Continuously variable transmissions use hydraulic variators including a hydraulic pump and motor.

### SUMMARY

According to an aspect of the present disclosure, a transmission assembly for a drivetrain of an agricultural tractive unit includes an input shaft, a first output shaft for a traction drive, a second output shaft for a PTO drive, and a first energy machine operatively connected to the input shaft via a branching stage, such that the power of the first energy machine is able to be transmitted to at least one coupled energy machine operatively connectable selectively to one or more of the first output shaft or the second output shaft via one or more clutches of a gear shift stage.

According to an aspect of the present disclosure, the at least one coupled energy machine includes a first coupled energy machine and a second coupled energy machine operatively connectable selectively to at least one of the first output shaft or the second output shaft via the one or more clutches of the gear shift stage.

According to an aspect of the present disclosure, the branching stage includes one of a branching gear set, a branching planetary gear, or at least one clutch of the gear shift stage.

According to an aspect of the present disclosure, the transmission assembly further includes a summing stage disposed between the branching stage and the first output shaft, the summing stage merging drive output from the branching stage and drive output from the at least one coupled energy machine.

According to an aspect of the present disclosure, the summing stage includes one of a summing gear set, a summing planetary gear, or the at least one clutch of the gear shift stage.

According to an aspect of the present disclosure, further includes a drive output-transmitting stage gear set disposed between the branching planetary gear and the first energy machine.

According to an aspect of the present disclosure, further includes a drive output-transmitting stage gear set disposed between the summing planetary gear and a coupled energy machine.

According to an aspect of the present disclosure, the branching stage is operatively connected to the summing stage, such that one or more of: a gear of the branching gear set is operatively connected to the summing planetary gear, a sun gear of the branching planetary gear is operatively connected to the summing planetary gear, a planetary carrier shaft of the branching planetary gear is operatively connected to a ring gear shaft of the summing planetary gear, or a sun gear of the branching planetary gear is operatively connected to a gear of the summing gear set.

According to an aspect of the present disclosure, the summing stage is operatively connected to at least one clutch of the gear switching stage, such that one or more of: the branching planetary gear is operatively connected to an output side of the at least one clutch of the gear shift stage, or the summing planetary gear is operatively connected to an output side of the at least one clutch of the gear shift stage.

According to an aspect of the present disclosure, the input shaft is operatively connected to one or more of the branching gear set, the branching planetary gear, the summing planetary gear, or a drive or output side of at least one clutch of the gear shift stage.

According to an aspect of the present disclosure, the first output shaft is operatively connected to one or more of a gear of a summing gear set, the summing planetary gear, the branching planetary gear, or a drive or output side of at least one clutch of the gear shift stage.

According to an aspect of the present disclosure, the at least one coupled energy machine includes a first coupled energy machine connected to the first output shaft for the traction drive and a second coupled energy machine connected to the second output shaft for the PTO drive.

According to an aspect of the present disclosure, the second coupled energy machine is connected to the first and second output shaft if a rotating speed of the first coupled energy machine is greater than the rotating speed threshold value.

According to an aspect of the present disclosure, the at least one coupled energy machine is operatively connected to the first output shaft via the summing stage.

According to an aspect of the present disclosure, one or more of the first energy machine or the at least one coupled energy machine is designed as an electric machine or as a hydraulic machine.

According to an aspect of the present disclosure, the transmission assembly further includes at least one energy accumulator which is connected to one or more of the first energy machine and the at least one coupled energy machine.

According to an aspect of the present disclosure, the input shaft of the transmission assembly is connectable to an internal combustion engine of the agricultural tractive unit.

The above and other features will become apparent from the following detailed description and accompanying drawings.

### BRIEF DESCRIPTION OF THE DRAWINGS

The disclosure will be explained in more detail hereunder with reference to the appended drawings. Components with identical or equivalent function herein are provided with the same reference signs. In the figures:

FIG. 1 shows a schematic illustration of an agricultural tractive unit according to the disclosure;

FIG. 2 shows an illustration in the manner of a block diagram of a first example embodiment of the architecture of the transmission assembly according to the disclosure;

FIG. 3 shows an illustration in the manner of a block diagram of a further example embodiment of the architecture of the transmission assembly according to the disclosure; and

FIG. 4A shows a schematic illustration of a first example embodiment of the architecture according to FIG. 2;

FIG. 4B shows a schematic illustration of a further example embodiment of the architecture according to FIG. 2;

FIG. 5A shows a schematic illustration of a further example embodiment of the architecture according to FIG. 2;

FIG. 5B shows a schematic illustration of a further example embodiment of the architecture according to FIG. 2;

FIG. 5C shows a schematic illustration of a further example embodiment of the architecture according to FIG. 2;

FIG. 6A shows a schematic illustration of a further example embodiment of the architecture according to FIG. 2;

FIG. 6B shows a schematic illustration of a further example embodiment of the architecture according to FIG. 2;

FIG. 7 shows a schematic illustration of a first example embodiment of the architecture according to FIG. 3;

FIG. 8 shows a schematic illustration of a further example embodiment of the architecture according to FIG. 3; and

FIG. 9 shows a schematic illustration of a further example embodiment of the architecture according to FIG. 3.

### DETAILED DESCRIPTION

The embodiments or implementations disclosed in the above drawings and the following detailed description are not intended to be exhaustive or to limit the present disclosure to these embodiments or implementations.

Known from EP 3 945 665 A1 is a transmission assembly for an agricultural machine, which contains, inter alia, an input shaft on an internal combustion engine, a power-branched transmission portion, a manual transmission, and an output shaft. The power-branched transmission section has a first coupled energy machine which is operatively connected to the input shaft and is electrically connected to a second coupled energy machine for power output. The second coupled energy machine is a constituent part of a magnetic-electric epicyclic gear stage, which merges mechanical and electrical drive output and transfers it to the manual transmission.

Proceeding from this approach, the disclosure is based on the object of proposing a transmission assembly and an agricultural tractive unit, which render the power output for a traction drive and/or PTO drive more variable and more efficient in a design of simple construction.

This object is achieved by means of a transmission assembly having the features of one or more of the embodiments disclosed herein, and by an agricultural tractive unit having the features of one or more of the embodiments disclosed herein. Some of the embodiments can relate to particularly advantageous embodiments of the disclosure.

Proposed according to one or more embodiments is a transmission assembly for a drivetrain of an agricultural tractive unit, for example a tractor or hauler. The transmission assembly comprises an input shaft, a first output shaft for a traction drive (e.g., with a final drive and a differential on a rear axle of the tractive unit), a second output shaft for a PTO drive and a first energy machine. This first energy machine is operatively connected, or operatively connectable, to the input shaft by way of a branching stage. The first energy machine is connected to at least one other energy machine (hereinafter: coupled energy machine) in such a manner that the first energy machine can transmit (in particular electrical or hydraulic) drive output to at least one coupled energy machine. In turn, at least one of the existing coupled energy machines can be operatively connected to the first output shaft and/or to the second output shaft by way of clutches of a gear shift stage.

Connected, or operatively connected, can be understood to mean mechanically connected, for example connected so as to be driven, thus connected in a torque and/or rotating speed-transmitting manner, and/or in a coupled or couplable manner, thus mechanically coupled and/or rigidly coupled or mechanically couplable. Mechanically connected, connected and/or coupled or couplable so as to be driven, or mechanically coupled and/or rigidly coupled or mechanically couplable, can therefore be understood to mean in particular a connection of two components which makes it possible to transmit an energy and/or a force and/or a torque and/or a rotating speed from one component to the other, in particular by way of a mechanical path. Further components or parts enabling such a transmission of energy and/or force and/or torque and/or transmission of a rotating speed between the two components can be provided between the two components herein.

Different operating states (e.g., closed or open) of the clutches can be utilized to distribute drive output variably on the output side of the transmission assembly. In this way, drive output from at least one coupled energy machine can be transmitted selectively only to the first output shaft or only to the second output shaft, or to both output shafts. For this selection, only the power flux between the coupled energy machine and the first and/or second output shafts has to be interrupted or closed. This is implemented by means of the clutches which establish or interrupt a drive connection between the coupled energy machine on the one hand and the first and/or second output shaft on the other.

For example, a coupled energy machine is operatively connectable to the first output shaft by way of a clutch and operatively connectable to the second output shaft by way of a further clutch.

The above-described structural design makes it possible to supply a traction drive and a PTO drive of the agricultural tractive unit with drive outputs of different magnitudes very efficiently. Drive speeds and drive torques can be altered very variably. In addition, the clutches support high-quality shifting of the transmission assembly using seamless switching operations at short switching times.

For example, all the coupled energy machines present in the transmission assembly are operatively connectable to the first output shaft and/or to the second output shaft selectively by way of clutches of the gear shift stages. This provides even more potential combinations for power output to the first output shaft and to the second output shaft. This enables more gear stages and their finer spacing.

In an embodiment, the branching stage comprises a branching gear set or a branching planetary gear. The branching gear set is designed in particular as a spur gear stage which for example has two mutually meshing gearwheels. The branching planetary gear can be designed as a simple planetary gear set (with sun gear, planetary gears, planetary carrier, ring gear) or as a complex planetary set (e.g. a plurality of combined planetary gear sets, common sun gear, common ring gear, at least four free shafts). Alternatively, at least one clutch of the gear shift stage in a dual function can be a functional component of the branching stage. The different component variants of the branching stage enable efficient power branching by simple technical means. At the same time, by selecting one of the three aforementioned alternatives, the number of gear stages that can be implemented for the transmission assembly can be easily altered in a technically simple manner.

In an embodiment, the transmission assembly contains a summing stage, i.e., a gear stage which merges drive output from the branching stage and drive output from at least one coupled energy machine. A combination of the summing stage with the branching stage and the gear shift stage facilitates the implementation of an increased number of gear stages while at the same time permitting a compact construction of the transmission assembly.

For example, the summing stage contains a summing gear set or a summing planetary gear. The summing gear set is designed in particular as a spur gear stage which for example has two mutually meshing gearwheels. The summing planetary gear can be designed as a simple planetary gear set (with sun gear, planetary gears, planetary carrier, ring gear) or as a complex planetary set (e.g. a plurality of combined planetary gear sets, common sun gear, common ring gear, at least four free shafts). Alternatively, at least one clutch of the gear shift stage in the context of a dual function can be a functional constituent part of the summing stage. The different component variants of the summing stage enable an efficient merging of drive output by simple technical means. At the same time, by selecting one of the three aforementioned alternatives, the number of gear stages that can be implemented can be individually adapted to the requirements of the transmission assembly.

Furthermore for example, disposed in the power flux between the branching planetary gear and the first energy machine is a stage gear set which transmits drive output between the two aforementioned components. Additionally or alternatively, disposed in the power flux between the summing planetary gear and a coupled energy machine is a stage gear set which transfers drive output between the two aforementioned components. The respective stage gear set is designed in particular as a spur gear stage which for example has two mutually meshing gearwheels. The respective stage gear set can functionally be a constituent part of the branching stage, or of the summing stage. By means of the stage gear set, an efficient transmission of drive output is possible, e.g., from the branching planetary gear in the direction of the first energy machine, or from the coupled energy machine in the direction of the summing planetary gear.

In a further embodiment of the disclosure, the branching stage with the summing stage and/or the summing stage with at least one clutch of the gear shift stage is operatively connected in a specific way so that the transmission assembly can be adapted efficiently to their functional requirements with simple technical measures. In particular, at least one of the following drive connections is implemented in the transmission assembly:
a gear of the branching gear set with a sun gear or a planetary carrier shaft, or with a ring gear shaft of the summing planetary gear,
a sun gear of the branching planetary gear with a sun gear, or with a planetary carrier shaft, or with a ring gear shaft of the summing planetary gear,
a planetary carrier shaft of the branching planetary gear with a ring gear shaft of the summing planetary gear,
a sun gear of the branching planetary gear with a gear of the summing gear set,
a sun gear or a planetary carrier shaft or a ring gear shaft of the branching planetary gear with a drive or output side of at least one clutch of the gear shift stage,
a sun gear or planetary carrier shaft or a ring gear shaft of the summing planetary gear with a drive or output side of at least one clutch of the gear shift stage.

The input shaft is operatively connected to at least one of the following components:
to a gear of the branching gear set,
to a sun gear or a planetary carrier shaft or a ring gear shaft of the branching planetary gear,
to a sun gear or a planetary carrier shaft or a ring gear shaft of the summing planetary gear,
to a drive or output side of at least one clutch of the gear shift stage.

The first output shaft is operatively connected to at least one of the following components:
to a gear of the summing gear set,
to a sun gear or a planetary carrier shaft or a ring gear shaft of the summing planetary gear,
to a sun gear or a planetary carrier shaft or a ring gear shaft of the branching planetary gear,
to a drive or output side of at least one clutch of the gear shift stage.

In a design embodiment of the disclosure, the one coupled energy machine, in particular a first coupled energy machine, is connected to the first output shaft for the traction drive, and the other one of the coupled energy machines, in particular a second coupled energy machine, is connected to the second output shaft for the PTO drive, if a rotating speed (n) of the first coupled energy machine is less than or equal to a rotating speed threshold value, and the second coupled energy machine is connected to the second output shaft if a rotating speed of the first coupled energy machine is greater than the rotating speed threshold value. Likewise, the second coupled energy machine can be connected to the first and second output shafts if a rotating speed (n) of the first coupled energy machine is greater than the rotating speed threshold value.

Based on the classification that the torque of the first coupled energy machine may be less than the torque threshold or greater than or equal to the torque threshold, and/or that the rotating speed of the first coupled energy machine may be less than or greater than or equal to the rotating speed threshold, two modes of transmission assembly and/or of the tractive unit are defined. In other words, two speed ranges of the transmission assembly and/or the tractive unit are defined.

The first mode, or the first speed range, is present when the torque of the first coupled energy machine is less than or equal to the torque threshold and/or the speed of the first coupled energy machine is less than or equal to the rotating speed threshold, i.e. when:

n≤n_{threshold} and/or T≤T_{threshold}

For example, if the torque of the first coupled energy machine is less than the torque threshold value and/or the rotating speed of the first coupled energy machine is less than the rotating speed threshold value, thus the following applies:

$$n < {n}_{threshold} and / or T < {T}_{threshold}$$

where
n=rotating speed of the first coupled energy machine
n_{threshold}=rotating speed threshold value, in particular the max. rotating speed of the first coupled energy machine
T=torque of the first coupled energy machine
T_{threshold}=torque threshold value, in particular the max. torque of the first coupled energy machine

A switching point exists when n=n_{threshold} and/or T=T_{threshold} applies. If the rotating speed of n the first coupled energy machine corresponds to the rotating speed threshold value n_{threshold}, in particular n=n_{threshold}, and/or if the torque T corresponds to the torque threshold value T_{threshold} i.e. if T=T_{threshold}, applies, a gear change is carried out, in particular a synchronized gear change to the second mode or the second speed range. The gear change can be performed under full load and without interruption of the tractive force, and in particular seamlessly. The first and second coupled energy machines can have the same rotating speed at the switching point, i.e. in particular if n=n_{threshold} and/or T=T_{threshold} applies. Due to the seamless switching, vibrations and/or shift-shocks of the transmission assembly can be avoided.

The second mode or the second speed range is present when the torque of the first coupled energy machine is greater than the torque threshold and/or the rotating speed of the first coupled energy machine is greater than the rotating speed threshold, thus when the following applies:

$$n > {n}_{threshold} and / or T > {T}_{threshold}$$

where
n=rotating speed of the first coupled energy machine
n_{threshold}=rotating speed threshold value, in particular the max. rotating speed of the first coupled energy machine
T=torque of the first coupled energy machine
T_{threshold}=torque threshold value, in particular the max. torque of the first coupled energy machine

In the first mode or the first speed range, the following applies, in particular the transmission assembly can be operated in the first mode or the first speed range as follows:
The first coupled energy machine, in particular only the first coupled energy machine, is connected to the traction drive, in particular coupled thereto, and the traction drive can be driven by the first coupled energy machine. The first coupled energy machine is thus the only machine capable of providing torque and/or rotating speed, in particular traction, for the traction drive. Thus, the transmission assembly, and especially at low speeds (n≤n_{threshold} and/or T≤T_{threshold}) the tractive unit, can be used with a constant single transmission ratio. In addition, a high traction torque and a high tractive force can be provided for the tractive unit at low speeds.
The second coupled energy machine, in particular only the second coupled energy machine, is connected to the first power output, in particular coupled thereto, and the first power output can be driven by the second coupled energy machine. The latter can thus provide torque and/or rotating speed for the first power output as the only machine.

In the second mode or the first speed range, the following applies, in particular the transmission assembly can be operated in the second mode or the second speed range as follows:
The second coupled energy machine, in particular only the second coupled energy machine, is connected to the traction drive, in particular coupled thereto, and the traction drive can be driven by the second coupled energy machine. The first coupled energy machine can be decoupled from the traction drive.
From this rotating speed and/or this torque, the first coupled energy machine provides no torque and/or rotating speed, in particular no traction, any more for the traction drive, and only the second coupled energy machine provides the torque and/or the rotating speed, in particular the complete traction for the traction drive.
Additionally, the first coupled energy machine, in particular only the first coupled energy machine, can be connected to the first power output, in particular coupled thereto, and the first power output can be driven by the first coupled energy machine. The latter can thus provide torque and/or rotating speed for the first power output as the only machine. Depending on the selected transmission ratios, synchronized switching of the first power output can be achieved.

In other words, the transmission assembly or the tractive unit can comprise a control unit. The control unit can be connected for signaling to the first and the second coupled energy machine, and/or be operatively coupled thereto, and/or connected thereto for signal transmission and/or data transmission. The control unit can be configured to receive one or more rotating speed signals and/or torque signals from the transmission assembly, in particular from rotating speed and/or torque sensors of the transmission assembly, and/or of the first and/or second coupled energy machine. The control unit may be configured to determine a rotating speed and/or torque using the rotating speed signal and/or the torque signal. The control unit can be configured to compare the rotating speed and/or torque obtained with the rotating speed threshold n_{threshold} and/or the torque threshold T_{threshold}. The control unit can be configured to set and/or adjust, and in particular also to operate at, the rotating speed and/or torque of the transmission assembly, in particular of the first and second coupled energy machine. The control unit can be configured to set and/or adjust the transmission assembly, in particular the first and second coupled energy machine, depending on the rotating speed and/or the torque in the first or second mode, in particular to operate in the first or second mode. The control unit can be configured to set and/or adjust the transmission assembly, in particular the first and second coupled energy machines, depending on the rotating speed and/or torque in the first mode, in particular to operate in the first mode, if the torque of the first coupled energy machine is less than a torque threshold and/or the rotating speed of the first coupled energy machine is less than a rotating speed threshold. Alternatively or additionally, the control unit can be configured to set and/or adjust the transmission assembly, in particular the first and second coupled energy machine, depending on the rotating speed and/or the torque in the second mode, in particular to operate in the second mode, if the torque of the first coupled energy machine is greater than or equal to the torque threshold and/or the rotating speed of the first coupled energy machine is greater than or equal to the rotating speed threshold. The control unit can be configured to set and/or adjust and/or actuate, for example also to control in an open loop and control in a closed loop, the transmission assembly and thus also the tractive unit depending on the rotating speed and/or the torque of the first coupled energy machine and/or the torque threshold and/or the rotating speed threshold, for example also to set and/or adjust the mode.

Synchronized switching of gears as in a two-speed transmission is possible, without actually requiring a second gear for one of the coupled energy machines. A seamless switching of gears can also be implemented. There is no need for a transmission with a variable transmission ratio. In this way, a compact design of the transmission assembly is also obtained. Due to the seamless switching, vibrations and/or shift-shocks of the transmission assembly can be avoided.

The clutches of the gear shift stage can be a first and a second clutch. The first coupled energy machine can be connected to the first clutch. Moreover, the first coupled energy machine can be connectable or connected, in particular releasably connected to the first clutch, or connectable or connected, in particular releasably connected, to the traction drive by way of the first clutch. For this purpose, the first output shaft can be connected to the first clutch. Alternatively or in addition, the second coupled energy machine is connected to the second clutch. Moreover, the second coupled energy machine can be connectable or connected, in particular releasably connected to the second clutch, or connectable or connected, in particular releasably connected, to the first power output by way of the second clutch. For this purpose, the second output shaft can be connected to the second clutch. The first clutch can be connectable or connected to the first output shaft. The second clutch can be connectable or connected to the second output shaft.

The first and second clutch can be movable between a first position, in particular a closed or connected or coupled state, and a second position, in particular an opened or non-connected or decoupled state. In the first position, the respective clutch can be connected to another component, such as the first or second output shaft. In the second position, the respective clutch may not be connected to the other component, for example the first or second output shaft, i.e., be disconnected therefrom

The first coupled energy machine can be connected to the first clutch or, by way of the first clutch in the first position, to the traction drive, in particular to the first output shaft, and in the second position not be connected to the traction drive, in particular to the first output shaft, thus be decoupled therefrom. The second coupled energy machine can be connected to the second or, by way of the second clutch in the first position, to the first power output, in particular to the second output shaft, and in the second position not be connected to the first power output, in particular to the second output shaft, thus be decoupled therefrom.

The first and/or second clutch can be configured as a coupling or synchronization, for example as a or a shift clutch or a multi-disk clutch or a gear synchronizer or a switchable overrunning clutch.

The transmission assembly can comprise a first transmission ratio stage, in particular a first spur gear stage or a first gearwheel set or a first gearwheel pair or a first planetary set. The first coupled energy machine can be connected to the first clutch by way of the first transmission ratio stage or by the first transmission ratio stage. The transmission assembly can comprise a second transmission ratio stage, in particular a second spur gear stage or a second gearwheel set or a second gearwheel pair or a second planetary set. The second coupled energy machine can be connected to the second clutch by way of the second transmission ratio or by the second transmission ratio.

The first and second clutches can be connected for signaling to the control unit and/or be operatively coupled and/or connected thereto for transmitting signals and/or transmitting data In particular, the transmission assembly can comprise a first valve or a first valve assembly, in particular a first control valve, or a first actuator for actuating and/or setting and/or adjusting the first clutch. The first valve or the first valve assembly or the first actuator can be connected to the first clutch. Likewise, the transmission assembly can comprise a second valve or a second valve assembly, in particular a second control valve, or a second actuator for actuating and/or setting and/or adjusting the second clutch. The second valve or the second valve assembly or the second actuator can be connected to the second clutch.

The control unit can be connected for signaling to the first and/or second valve or to the first and/or second valve assembly or to the first and/or second actuator and/or be operatively coupled and/or connected thereto for transmitting signals and/or data. The control unit can be configured to actuate and/or set and/or adjust the first clutch, in particular by way of the first valve or by the first valve or the first valve assembly or the first actuator. The control unit can be configured to set and/or adjust the first clutch, in particular by way of or by the first valve or the first valve assembly or the first actuator, to the first or second position and/or, in particular, also to move the first clutch from the first to the second position and vice versa. The control unit can be configured to actuate and/or set and/or adjust the second clutch, in particular by way of the second valve or by the second valve or the second valve assembly or the second actuator. The control unit can be configured to set and/or adjust the second clutch, in particular by way of the or by the second valve or the second valve assembly or the second actuator, to the first or second position, in particular also to move the second clutch from the first to the second position and vice versa. The transmission assembly has the advantages mentioned above.

The transmission assembly can comprise a third clutch. The second coupled energy machine can be connected to the third clutch. Moreover, the second coupled energy machine can be connectable or connected to the traction drive by or by way of the third clutch. The third clutch can be connectable or connected to the first output shaft. Additionally or alternatively, the transmission assembly can comprise a fourth clutch, and the first coupled energy machine is connected to the fourth clutch. Moreover, the first coupled energy machine can be connectable to or connected to the first power output by or by way of the fourth clutch. The fourth clutch can be connectable or connected to the second output shaft.

The third and fourth clutch can in each case be movable between a first position, in particular a closed or connected or coupled state, and a second position, in particular an opened or non-connected or decoupled state. In the first position, the respective clutch can be connected to another component, such as the first or the second output shaft. In the second position, the respective clutch may not be connected to the other component, for example the first or second output shaft, i.e., be disconnected therefrom

The first coupled energy machine by the fourth or by way of the fourth clutch in the first position can be connected to the first power output, in particular the second output shaft, and in the second position not be connected to the first power output, in particular the second output shaft, thus be decoupled therefrom. The second coupled energy machine by the third or by way of the third clutch in the first position can be connected to the traction drive, in particular the first output shaft, and in the second position not be connected to the traction drive, in particular the first output shaft, thus be decoupled therefrom.

The third and/or the fourth clutch can be configured as a clutch or synchronization, for example as a or a shift clutch or a multi-disk clutch or a gear synchronizer or a switchable overrunning clutch.

The transmission assembly can comprise a third transmission ratio stage, in particular a third spur gear stage or a third gearwheel set or a third gearwheel pair or a third planetary set. The second coupled energy machine can be connected to the third clutch by the third transmission ratio stage or by way of the third transmission ratio stage. The transmission assembly can comprise a fourth transmission ratio stage, in particular a fourth spur gear stage or a fourth gearwheel set or a fourth gearwheel pair or a fourth planetary set. The first coupled energy machine can be connected to the fourth clutch by way of the fourth transmission ratio stage or by the fourth transmission ratio stage.

The third and/or the fourth clutch can be connected to the control unit for signal transmission and/or be operatively coupled and/or connected thereto for signal transmission and/or data transmission. In particular, the transmission assembly can comprise a third valve or a third valve assembly, in particular a third control valve, or a third actuator for actuating and/or setting and/or adjusting the third clutch. The third valve or the third valve assembly or the third actuator can be connected to the third clutch. Likewise, the transmission assembly may comprise a fourth valve or a fourth valve assembly, in particular a fourth control valve, or a fourth actuator, for actuating and/or setting and/or adjusting the fourth clutch. The fourth valve or the fourth valve assembly or the fourth actuator can be connected to the fourth clutch.

The control unit can be connected for signaling to the third and/or the fourth valve or the third and/or the fourth valve assembly or the third and/or the fourth actuator and/or be operatively coupled and/or connected thereto for signal transmission and/or data transmission. The control unit can be configured to actuate and/or set and/or adjust the third clutch, in particular by way of or by the third valve or the third valve assembly or the third actuator. The control unit can be configured to set and/or adjust the third clutch, in particular by way of or by the third valve or the third valve assembly or the third actuator, to the first or the second position and/or, in particular, also to move the third clutch from the first to the second position and vice versa. The control unit may be configured to actuate and/or set and/or adjust the fourth clutch, in particular by way of or by the fourth valve or the fourth valve assembly or the fourth actuator. The control unit can be configured to set and/or adjust the fourth clutch, in particular by way of or by the fourth valve or the fourth valve assembly or the fourth actuator, to the first or second position, in particular, also to move the move from the first to the second position and vice versa.

Furthermore for example, the first energy machine can be operatively connectable to the second output shaft by way of a clutch of the gear shift stage. Alternatively or additionally, the first energy machine can be operatively connectable to the first output shaft by way of another clutch of the gear shift stage. As a result, the first energy machine can assume the functionality of a coupled energy machine in terms of the gear shift stage. In this way, other specific architectural solutions for the transmission assembly can be implemented if required.

In a design embodiment of the disclosure, a coupled energy machine is operatively connected to the first output shaft by way of the summing stage. This technical design embodiment facilitates flexible architectural solutions for the transmission assembly.

In some embodiments, the first energy machine and/or at least one coupled energy machine is designed as a coupled energy machine (in particular electric motor) or as a hydraulic machine. As a result, the individual energy machines can be adapted to the respective most efficient requirements (e.g., on the tractive unit) in terms of energy supply.

For example, the transmission assembly contains at least one energy accumulator for the energetic connection to the first energy machine and/or to at least one coupled energy machine. Since the energy machines are already present in the transmission assembly in the first place, the at least one energy accumulator enables an efficient hybrid drive architecture for the tractive unit with only a minor amount of additional complexity. A combination of technologically different energy accumulators can also be provided if technologically different energy machines are present. In particular, an electrical energy accumulator and/or a hydraulic energy accumulator are/is provided. The energy accumulator can supply the connected energy machine(s) with energy. Conversely, in a specific mode of operation of the tractive unit, the energy accumulator can be recharged with energy by the connected energy machine(s). The energy accumulator can be designed as an electric battery, or a rechargeable battery, respectively. In the case of a hydraulic energy accumulator, the latter can be supplied by an operating hydraulics on board the tractive unit, for example.

The disclosure furthermore relates to an agricultural tractive unit, for example a tractor, having a transmission assembly of one or more of the embodiments disclosed herein. The agricultural tractive unit can moreover comprise a drive motor, in particular an internal combustion engine. This drive motor is connected to, or connectable to, the input shaft. The transmission assembly here can be drivable by the drive motor and be in drive connection with at least one vehicle axle of the tractive unit and/or may be able to be placed in drive connection with a further drive axle of the tractive unit. The tractive unit according to the disclosure has the above-described advantages of the transmission assembly according to the disclosure.

The transmission assembly according to the disclosure and the tractive unit according to the disclosure enable an efficient combination of a power-branched gear stage (branching stage) with a drive output merging gear stage (summing stage) and a gear shift stage, which can be designed as a full-load manual transmission. The combination of the above-mentioned stages can implement a large number of gear stages using a comparatively single construction in association with a correspondingly improved functionality and performance of the transmission assembly. The number of gear stages implemented can be varied in a simple way in that the branching stage and/or the summing stage are each equipped with at least one specific transmission (e.g., spur gear stage, simple or complex planetary gear). In particular, the number of free shafts in the planetary gear(s) can be varied in order to achieve a different number of gear stages.

The first coupled device, in particular the first valve or the first valve device or the first actuator, and/or the second clutch device, in particular the second valve or the second valve device or the second actuator, and/or the third clutch device, in particular the third valve or the third valve device or the third actuator, and/or the fourth clutch device, in particular the fourth valve or the fourth valve device or the fourth actuator, and/or the energy storage and/or the power electronics and/or the first and/or second coupled energy machine and/or the PTO drive, can be able to be operated by the control unit, for example controllable in an open and/or closed loop, for example actuatable and/or settable and/or adjustable by the latter. The control unit can send and/or receive signals to control the operation of the drive assembly and/or the axle and/or the work machine. The signals can be expediently provided by way of a suitable data communication network, for example one that conforms to the ISOBUS standard. The control unit can be designed as an electronic module, an embedded system, a computing unit, a computer, as a module for controlling in an open and/or closed loop the drive assembly and/or the tractive unit. The control unit can comprise one or a plurality of processors, a memory and/or all the software, hardware, algorithms, connectors, and in particular also sensors, required for controlling in an open and/or closed loop the drive assembly and/or the axle and/or the work machine. Methods can be configured as a program or algorithm that can be executed on and/or by the control unit. The control unit can comprise any device that analyses data from various sensors, compares data and makes the necessary decisions to control in an open loop and/or closed loop and/or carry out, the operation of the drive assembly and/or the axle and/or the work machine and the necessary tasks for controlling in an open and/or closed loop the operation of the drive assembly and/or the axle and/or the work machine. The control unit can be connected for signaling and/or operatively coupled and/or connected for transmitting signals and/or transmitting data, to the components of the drive assembly and/or the axle and/or the work machine, thus in particular to the traction drive and/or the first power output, in particular the PTO unit, and/or the first clutch device, in particular the first valve or the first valve device or the first actuator, and/or the second clutch device, in particular the second valve or the second valve device or the second actuator, and/or the third clutch device, in particular the third valve or the third valve device or the third actuator, and/or the fourth clutch device, in particular the fourth valve or the fourth valve device or the fourth actuator, and/or the fifth clutch device, in particular the fifth valve or the fifth valve device or the fifth actuator, and/or the sixth clutch device, in particular the sixth valve or the sixth valve device or the sixth actuator, and/or the energy accumulator and/or the power electronics and/or the first and/or second coupled energy machine, the sensors, for example the speed sensor and/or the rotating speed and/or torque sensor(s). Connected for signaling and/or operatively coupled and/or a connection for transmitting signals and/or conducting data can be understood as meaning, inter alia, that signals and/or data can be exchanged between the connected parts and the control unit. Signals can for example be received and transmitted, and/or processed and/or manipulated, by the control unit. The connection between the control unit as well as the parts or components of the drive assembly and/or the axle and/or the work machine can be implemented by wire, thus in particular using cables, and/or in a wireless manner, thus by radio, for example using Bluetooth or WLAN. Communications can take place, for example, by means of Isobus, CAN bus, or similar. The control unit can be connected directly to the input and output unit which is disposed in a cab of the work machine, and by means of which data entered by an operator can be transmitted to the control unit, or data can be received from the control unit and outputted. The control unit can be integrated into the input and output unit or vice versa.

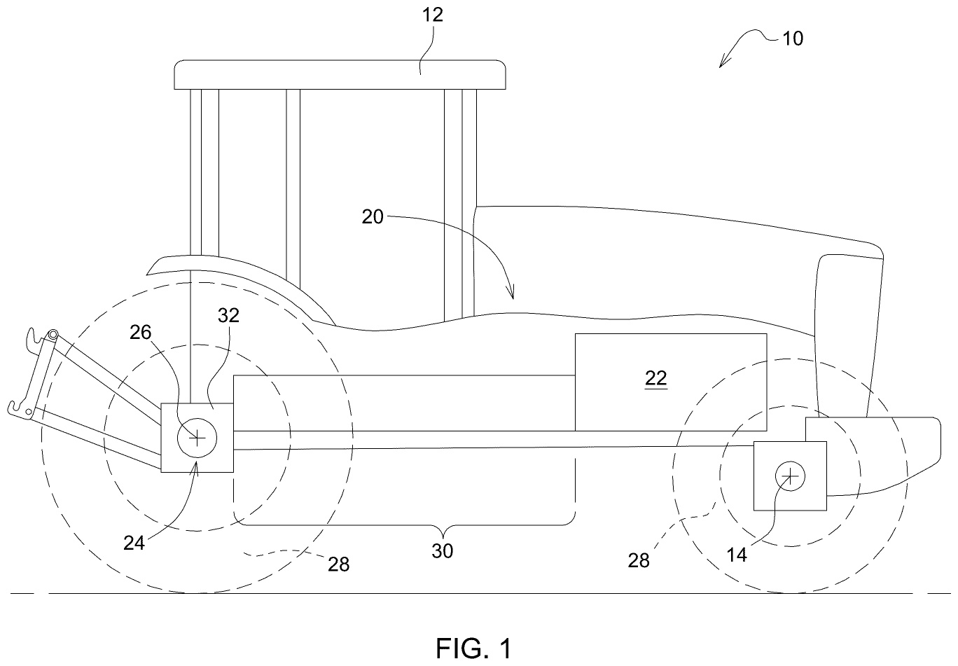

FIG. 1 shows a schematic illustration of an agricultural tractive unit 10 according to the disclosure, in particular in the form of a tractor, with a drivetrain 20 in a potential design embodiment. The fundamental construction of an agricultural tractive unit 10 is assumed to be known to a person skilled in the art. The tractive unit 10 furthermore comprises a cab 12, a front vehicle axle 14 and a rear vehicle axle 26. The front vehicle axle 14 and the rear vehicle axle 26 are part of the drivetrain 20, wherein the rear vehicle axle 26 can typically be permanently driven and the front vehicle axle 14 can typically be driven so as to be activated on demand.

The drivetrain 20 furthermore comprises a drive motor 22, which can be embodied as an internal combustion engine, and a transmission structure. Proceeding from the drive motor 22, the transmission structure described in the present case, in terms of the force flux and torque flux, can have a transmission assembly 30 according to the disclosure, and a traction drive 24 on the rear vehicle axle 26, having a rear final drive 32 and a differential 34 (compensation transmission).

Using the transmission assembly 30, drive output from the drive motor 22 can be transmitted by different gear stages to a first output shaft 40 and to a second output shaft 42 of the transmission assembly 30. The rear vehicle axle 26, which is operatively connected to the first output shaft 40 and converts a rotation of the front and/or the rear vehicle axle (by way of ground engagement means connected thereto) into propulsion of the tractor, can therefore be driven at a different rotating speed, depending on a gear stage selected in the transmission assembly 30. Consequently, a tractor equipped with the transmission assembly 30 is movable in different speed ranges, depending on the gear stage selected in the transmission assembly 30.

The tractive unit 10 can have one or more ground engagement means in the form of wheels 28 which are in engagement with an underlying surface to transmit drive forces and/or by way of which the tractive unit 10 is supported on the underlying surface. The tractive unit 10 can, moreover, have a chassis, such that the chassis can in particular be supported by the wheels suspended on the front and the rear vehicle axle 14, 26.

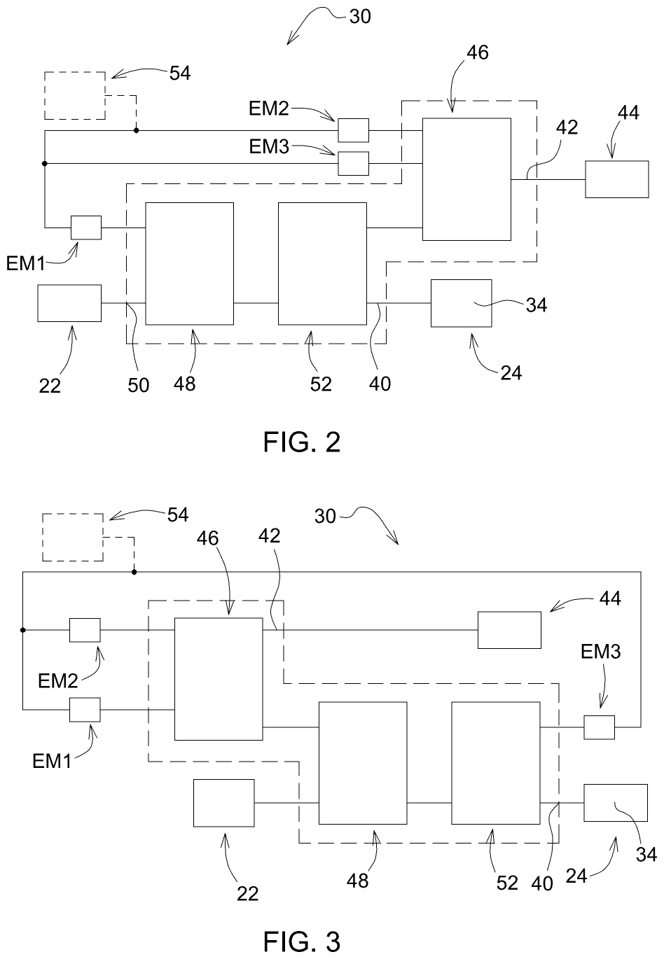

FIG. 2 shows a schematic illustration of the transmission assembly 30, having a first architecture. In this case, the second output shaft 42, which provides drive output for a PTO drive 44, is connected to a gear shift stage 46. Furthermore, two coupled energy machines EM2, EM3 which are able to be driven by a first energy machine EMI are connected to the gear shift stage 46.

The first energy machine EMI is operatively connected to an input shaft 50 of the transmission assembly 30 by way of a branching stage 48. The input shaft 50 is operatively connected in a customary way to the internal combustion engine 22. Disposed between the branching stage 48 and the transmission switching stage 46 is a summing stage 52 which merges a drive output. The summing stage 52 can direct drive output to the first output shaft 40 and thus to the traction drive 24 with the differential 34, or to the rear vehicle axle 26, respectively.

Optionally, at least one energy accumulator 54 (e.g., an electrical and/or a hydraulic energy accumulator) can be provided, which is indicated by dashed lines in FIG. 2. As a result, the energy machines EM1, EM2, EM3 can be supplied with energy for a hybrid drive of the tractive unit 10. Moreover, the energy machines EM1, EM2, EM3 can optionally recharge the at least one energy accumulator 54.

FIG. 3 shows a schematic illustration of the transmission assembly 30 having a further architectural solution. In contrast to the solution according to FIG. 2, the first energy machine EM1 in FIG. 3 is connected to the gear shift stage 46, while the coupled energy machine EM3 is connected to the summing stage 52. The first energy machine EM1 is in turn connected to the branching stage 48 by way of the intervening transmission switching stage 46. Moreover, the first energy machine EM1 in the variant according to FIG. 3 can also drive the two coupled energy machines EM2, EM3.

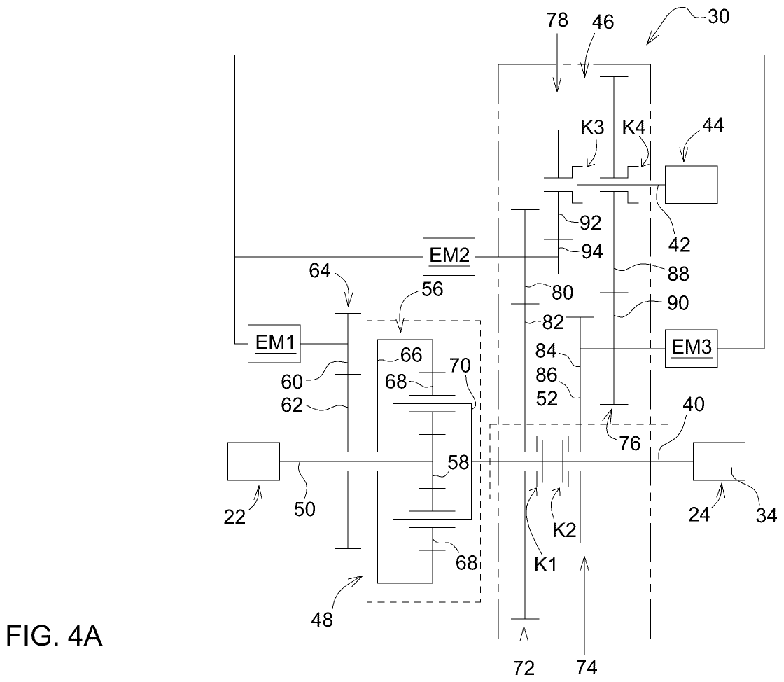

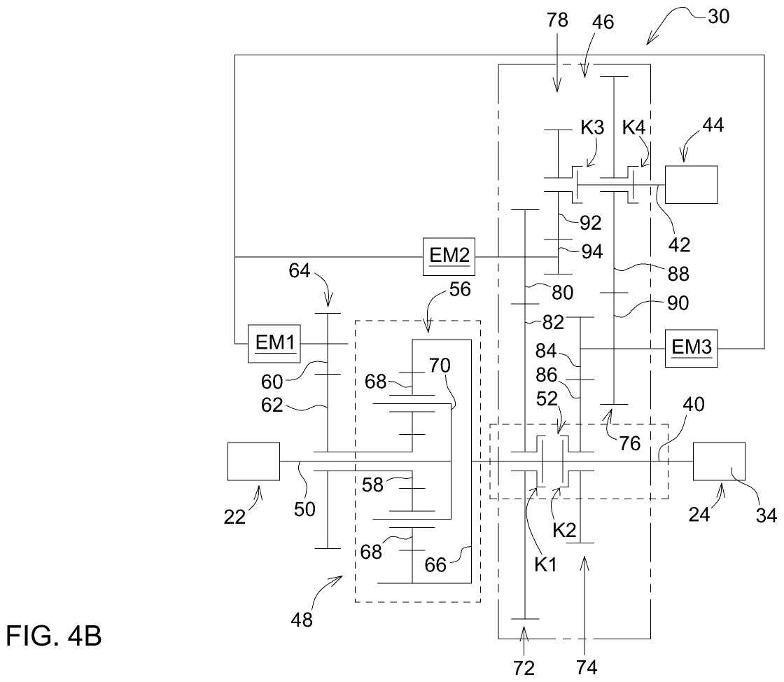

FIG. 4A shows a first embodiment of the architectural solution according to FIG. 2 in the form of a diagram. In this embodiment, the branching stage 48 has a planetary gear 56 (hereinafter branching planetary gear 56). The input shaft 50 is operatively connected, in particular co-rotationally connected, to a sun gear 58 of the branching planetary gear 56. The first energy machine EMI is operatively connected to a ring gear shaft 66 of the branching planetary gear 56, by way of an intervening stage gear set 64 designed as a spur gear stage having two gears 60, 62. Here, the first energy machine EMI is co-rotationally connected to the gear 60, while the gear 62 is co-rotationally connected to the ring gear shaft 66. The input shaft-proximal stage gear set 64 can be functionally a part of the branching stage 48. The planetary gears 68 of the branching planetary gear 56 are mounted on a planetary gear carrier, the planetary carrier shaft 70 thereof being operatively connected, in particular co-rotationally connected, to the first output shaft 40.

The gear shift stage 46 according to FIG. 4A contains a first gear set 72, a second gear set 74, a third gear set 76, a fourth gear set 78 and four clutches K1, K2, K3, K4. Each gear set 72, 74, 76, 78 has two mutually interacting gears 80 and 82, 84 and 86, 88 and 90, 92 and 94.

The coupled energy machine EM2 is co-rotationally connected to the gear 80 of the first gear set 72, while the gear 82 of the latter is co-rotationally connected to the clutch K1, in particular to the clutch side thereof used as the drive side. Moreover, the coupled energy machine EM2 is co-rotationally connected to the gear 94 of the fourth gear set 78, while the gear 92 is co-rotationally connected to the clutch K3, in particular to the clutch side thereof used as the drive side.

The coupled energy machine EM3 is co-rotationally connected to the gear 84 of the second gear set 74, while the gear 86 is co-rotationally connected to the clutch K2, in particular to the clutch side thereof used as the drive side. Moreover, the coupled energy machine EM3 is co-rotationally connected to the gear 90 of the third gear set 76, while the gear 88 thereof is co-rotationally connected to the clutch K4, in particular to the clutch side thereof used as the drive side.

The clutches K1, K2 are on the output side co-rotationally connected to the first output shaft 40. On the drive side, the clutch K3 is co-rotationally connected to the gear 92 of the fourth gear set 78 and on the output side is co-rotationally connected to the second output shaft 42. As already mentioned, the K4 clutch is co-rotationally connected to the drive side with the wheel 88 and on the output side is co-rotationally connected to the second output shaft 42. The two clutches K1, K2 in the context of a dual function can have the effect of merging drive output, and to this extend also correspond to a function of the summing stage 52 already mentioned.

FIG. 4B shows the transmission assembly 30 having the gear shift stage 46, the branching stage 48 and the summing stage 52 according to FIG. 4A, but having to some extent differently implemented drive connections between the input shaft 50 and the first output shaft 40. In FIG. 4B, the input shaft 50 is operatively connected to the planetary carrier shaft 70 of the branching planetary gear 56. The sun gear 58 of the latter is operatively connected to the gear 62 of the stage gear set 64. The ring gear shaft 66 of the branching planetary gear 56 is operatively connected to the first output shaft 40.

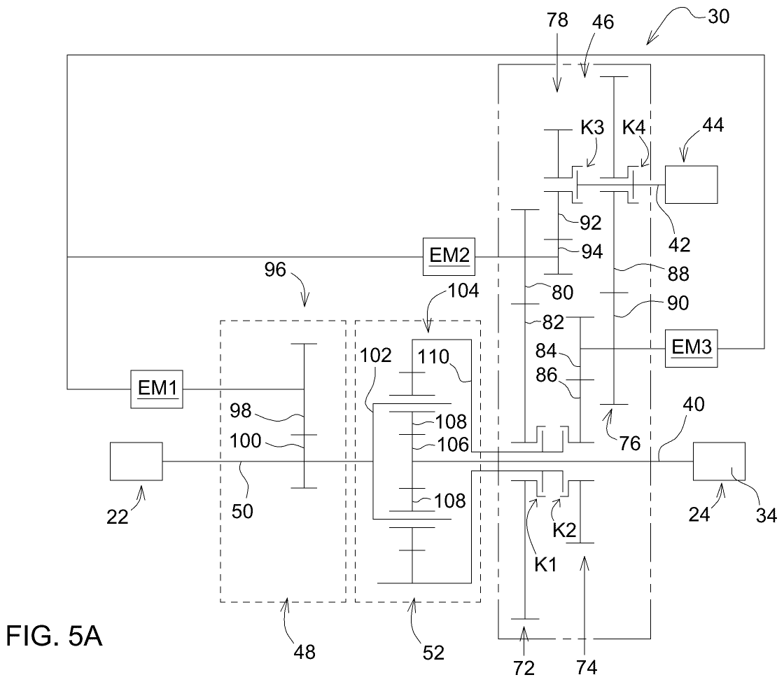

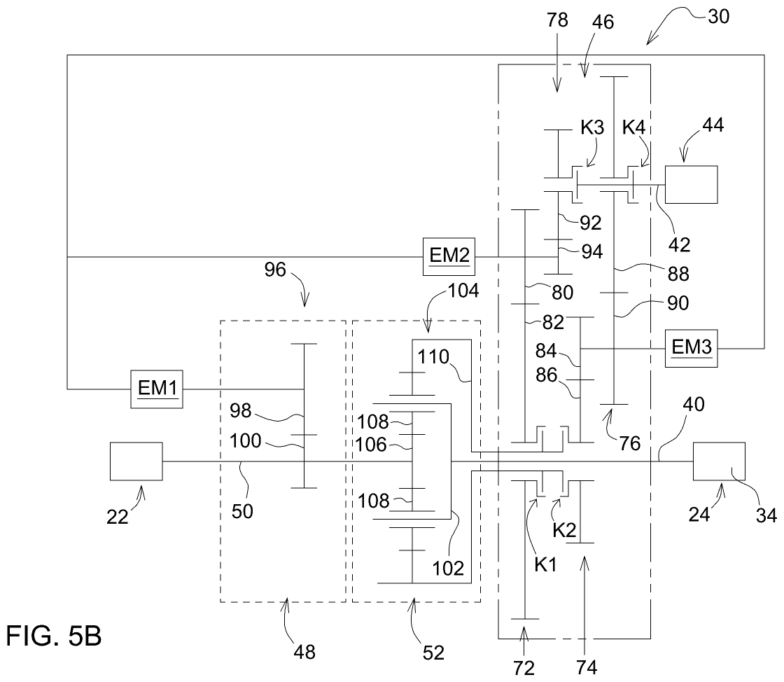

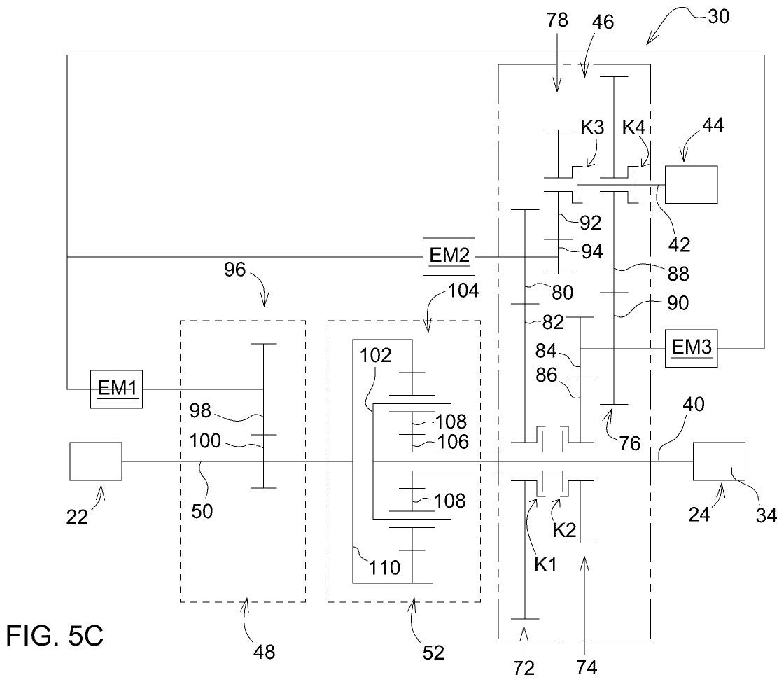

FIG. 5A shows in the form of a diagram another embodiment of the architectural solution according to FIG. 2. In this embodiment, the branching stage 48 has a gear set 96 (hereinafter also branching gear set 96) formed as a spur gear stage with two interacting gears 98, 100. The input shaft 50 is operatively connected to the first energy machine EM1 by way of the branching gear set 96. The input shaft 50 is co-rotationally connected to the gear 100, while the first energy machine EMI is co-rotationally connected to the gear 98. In addition, the gear 100 is operatively connected, in particular co-rotationally connected, to a planetary carrier shaft 102.

The planetary carrier shaft 102 is a constituent part of a planetary gear 104 with a sun gear 106 and a plurality of planet gears 108. The planetary gear 104 (also summing planetary gear 104) is disposed in the power flux in such a manner that it has a drive output merging effect and is therefore a constituent part of the summing stage 52. In particular, drive output is directed into the summing stage 52 by way of a ring gear shaft 110 which is operatively connected to an output side of the clutches K1, K2. The merged drive output can be transmitted by way of the sun gear 106 to the first output shaft 40.

In FIG. 5B, the drive connections between the input shaft 50, the summing planetary gear 104 and the first output shaft 40 are implemented differently compared to the embodiment according to FIG. 5A. Here, in FIG. 5B, the input shaft 50 is operatively connected to the sun gear 106 of the summing planetary gear 104, while the planetary carrier shaft 102 of the summing planetary gear 104 is operatively connected to the first output shaft 40. The ring gear shaft 110 is—as in the variant according to FIG. 5A—operatively connected to an output side of the clutches K1, K2.

FIG. 5C shows a further variant of the drive connections between the input shaft 50, the summing planetary gear 104 and the first output shaft 40 compared to FIG. 5A. Here, in FIG. 5C, the input shaft 50 is operatively connected to the ring gear shaft 110 of the summing planetary gear 104, while the planetary carrier shaft 102 of the summing planetary gear 104 is operatively connected to the first output shaft 40. The sun gear 106 of the summing planetary gear 104 is operatively connected to an output side of clutches K1, K2.

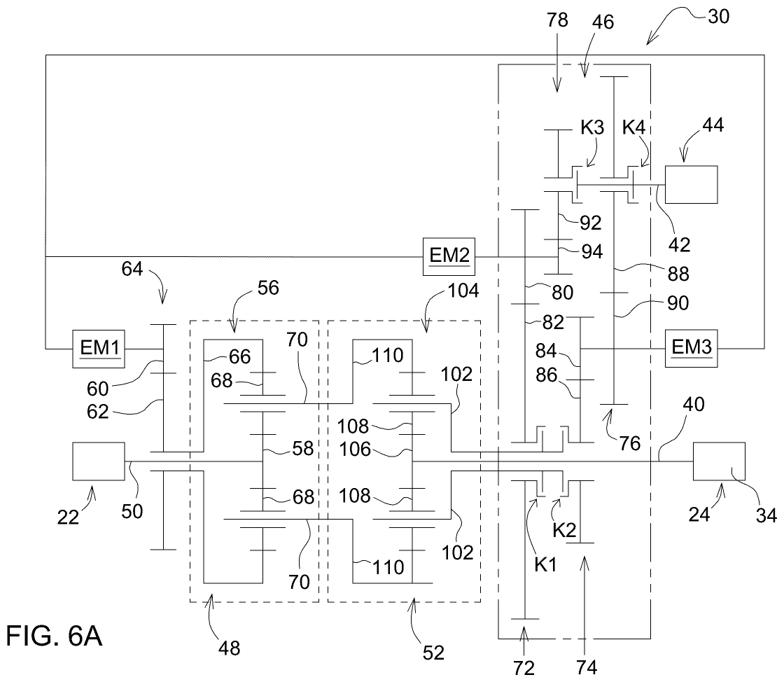

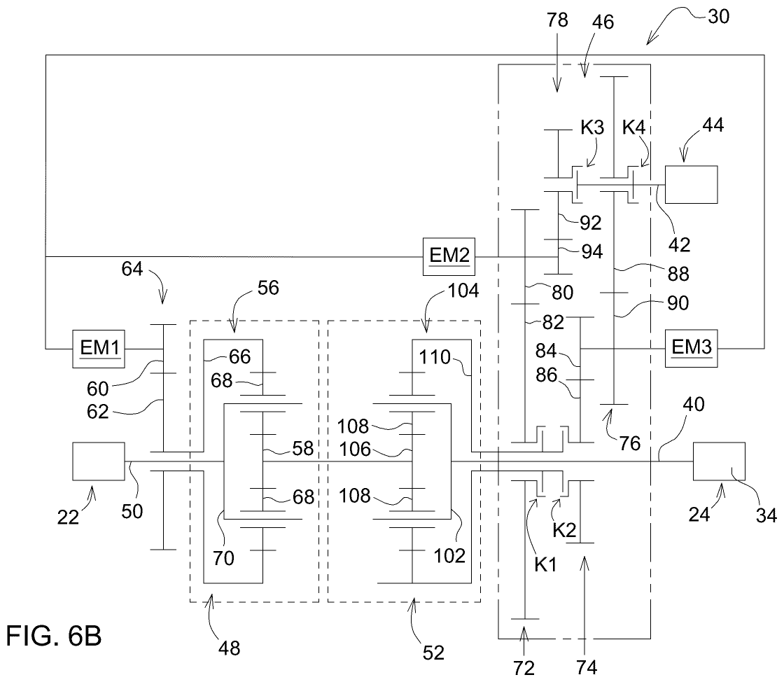

FIG. 6A shows in the form of a diagram another embodiment of the architectural solution according to FIG. 2. In this embodiment, the branching stage 48 has the branching planetary gear 56, but to some extent with other drive connections than in FIGS. 4A, 4B. The summing stage 52 has the summing planetary gear 104, but to some extent with different drive connections than in FIGS. 5A, 5B, 5C. The input shaft 50 in FIG. 6A is operatively connected to the sun gear 58 of the branching planetary gear 56. The planetary carrier shaft 70 of the branching planetary gear 56 is operatively connected, in particular co-rotationally connected, to the ring gear shaft 110 of the summing planetary gear 104. The summing planetary gear 104 in turn has the merging effect for drive output explained in the embodiments according to FIGS. 5A, 5B, 5C. However, in FIG. 6A, drive output is transmitted to the summing stage 52 in particular by way of the planetary carrier shaft 102 which is operatively connected to an output side of the clutches K1, K2. Analogous to the embodiment according to FIG. 5A, the sun gear 106 of the summing planetary gear 104 is operatively connected, in particular co-rotationally connected, to the first output shaft 40 also in FIG. 6A.

In FIG. 6B, the drive connections between the input shaft 50, the branching planetary gear 56, the summing planetary gear 104, the clutches K1, K2 and the first output shaft 40 are implemented differently compared to the embodiment according to FIG. 6A. In FIG. 6B, the input shaft 50 is operatively connected to the planetary carrier shaft 70 of the branching planetary gear 56, while the planetary carrier shaft 102 of the summing planetary gear 104 is operatively connected to the first output shaft 40. Moreover, the two sun gears 58, 106 are operatively connected, in particular co-rotationally connected, to one another. The ring gear shaft 110 of the summing planetary gear 104 is—as in the variants according to FIGS. 5A, 5B—operatively connected to an output side of the clutches K1, K2.

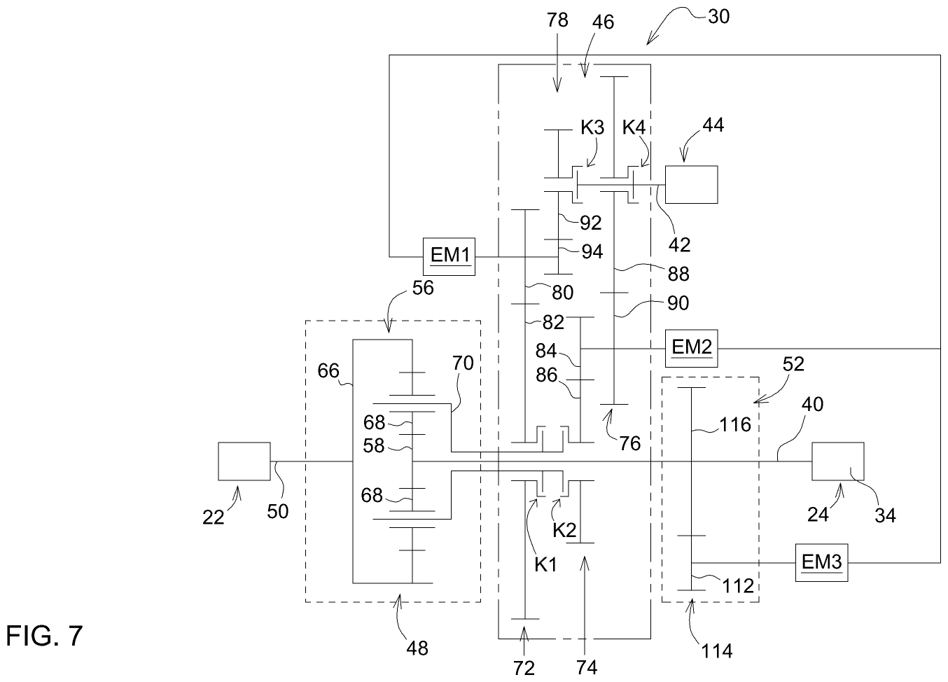

FIG. 7 shows a first embodiment of the architectural solution according to FIG. 3 in the form of a diagram. In this embodiment, the branching stage 48 has the branching planetary gear 56. The input shaft 50 is operatively connected, in particular co-rotationally connected, to the ring gear shaft 66 of the branching planetary gear 56. The sun wheel 58 of the branching planetary gear 56 is operatively connected, in particular co-rotationally connected, to the first output shaft 40. The planetary carrier shaft 70 of the branching planetary gear 56 is operatively connectable at least by way of the clutch KI in such a manner that also the first energy machine EM1 by way of the branching stage 48 is operatively connectable to the input shaft 50 and can consequently be supplied with a proportional drive output. Analogously, in an embodiment, the coupled energy machine (presently EM2) which is operatively connected to the second and the third gear set 74, 76 can be supplied with a proportional drive output of the input shaft 50 by way of the clutch K2.

As can be seen in FIG. 7, in the architecture according to FIG. 3 the first energy machine EM1 is operatively connected, in particular co-rotationally connected, to the gear 80 of the first gear set 72. One of the coupled energy machines EM2, EM3 (presently EM2) is furthermore operatively connected to the gear 90 of the third gear set 76. In contrast to the architectural solution according to FIG. 2, however, in the gearbox architecture according to FIG. 3 one of the coupled energy machines EM2, EM3 (here EM3) is operatively connected to the summing stage 52. In FIG. 7, a co-rotational connection between the coupled energy machine EM3 and a gear 112 of a gear set 114 is provided for this purpose. The gear set 114 in the form of a spur gear stage acts as the summing stage 52 and has two interacting gears 112, 116. The gear 116 is co-rotationally connected to the first output shaft 40.

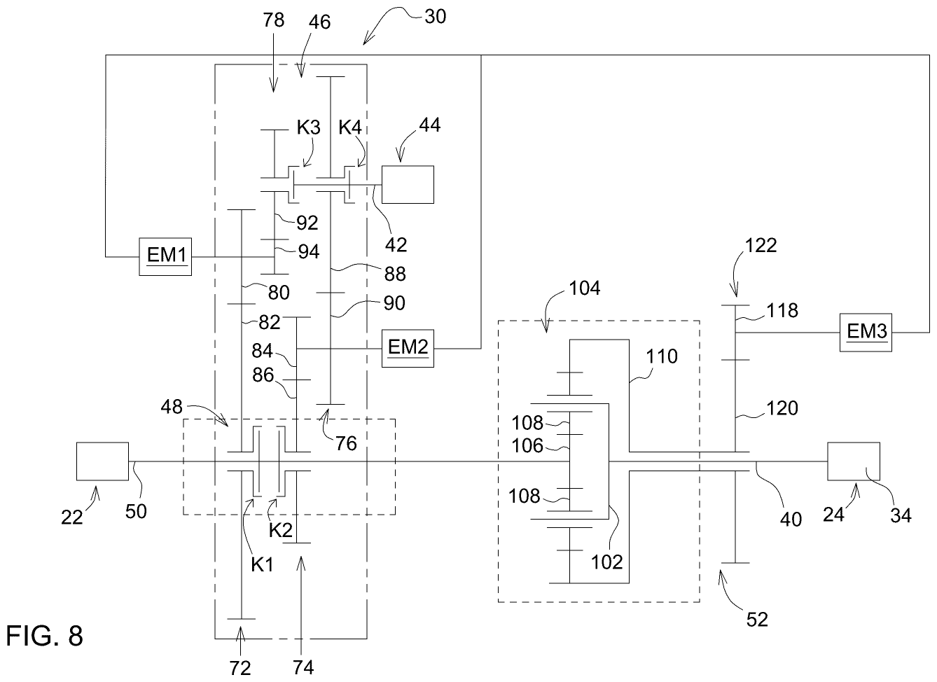

FIG. 8 shows in the form of a diagram another embodiment of the architectural solution according to FIG. 3. In this embodiment, the summing stage 52 comprises the summing planetary gear 104. A coupled energy machine (here EM3) is operatively connected to the ring gear shaft 110 of the summing planetary gear 104 by way of an intervening stage gear set 122 which is designed as a spur gear stage having two gears 118, 120. The coupled energy machine EM3 is co-rotationally connected to the gear 118, while the gear 120 is co-rotationally connected to the ring gear shaft 110. The output shaft-proximal stage gear set 122 can be functionally a constituent part of the summing stage 52.

As can furthermore be derived from FIG. 8, the input shaft, or an extension thereof, can be operatively connected, in particular co-rotationally connected, to the sun gear 106 of the summing planetary gear 104. Drive output can be directed to summing stage 52 by way of the sun gear 106 and the ring gear shaft 110. The merged drive output can be transmitted by way of the planetary carrier shaft 102 to the first output shaft 40.

The first energy machine EMI can, as in the variant according to FIG. 7, fundamentally also in the embodiment according to FIG. 8, receive a power-branched, i.e., a proportional drive output from the input shaft 50. For this purpose, the K1 clutch is actuated and for example transferred to its closed state. Analogously, in an embodiment, the coupled energy machine (presently EM2) which is operatively connected to the second and the third gear set 74, 76 can be supplied with a proportional drive output of the input shaft 50 by way of the clutch K2. To this extent, the two clutches K1, K2 in the embodiment according to FIG. 8 can functionally have the effect of power branching a drive output, and in this respect also correspond to a function of the branching stage 48.

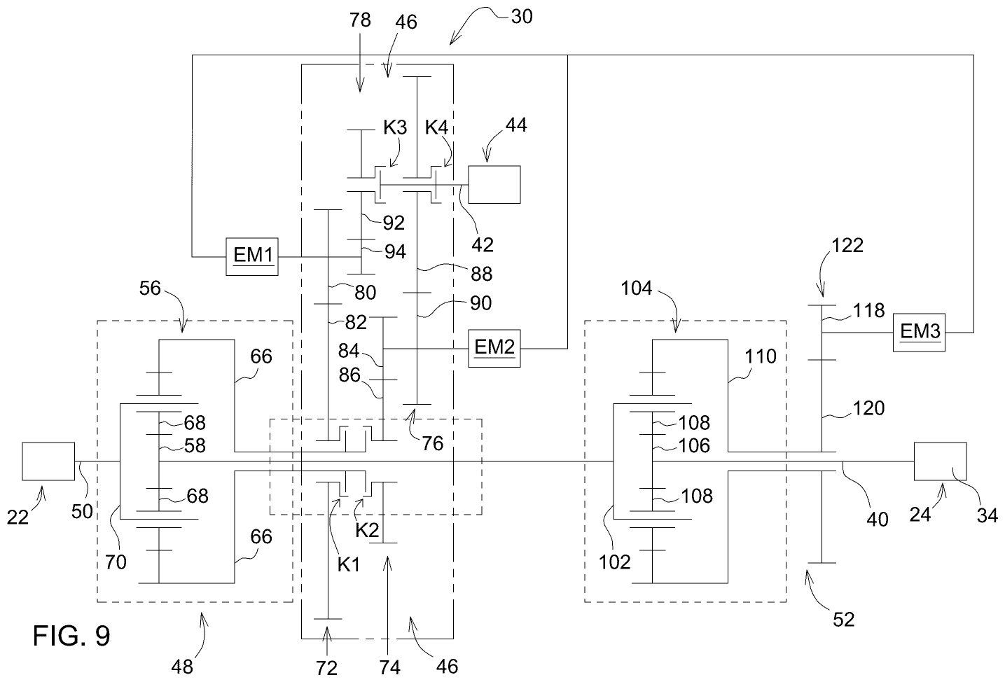

FIG. 9 shows in the form of a diagram another embodiment of the architectural solution according to FIG. 3. In this embodiment, the summing stage 52 is operatively connected to a coupled energy machine (presently EM3). The first output shaft 40 is operatively connected, in particular co-rotationally connected, to the sun gear 106 of the summing planetary gear 104.

In FIG. 9, the input shaft 50 is fundamentally operatively connected to the branching stage 48 and the branching planetary gear 56, analogous to the variant according to FIG. 7. However, the input shaft 50 in FIG. 9 is operatively connected, in particular co-rotationally connected, to the planetary carrier shaft 70 of the branching planetary gear 56. The ring gear shaft 66 of the branching planetary gear 56 is coupled to the two clutches K1, K2 in such a way that the first energy machine EM1 and for example also a coupled energy machine (presently EM2) can be supplied with a proportional drive output from the input shaft 50 by way of the branching stage 48. The sun gear 58 of the branching planetary gear 56 is operatively connected, in particular co-rotationally connected, to the planetary carrier shaft 102 of the summing planetary gear 104.

In all embodiments, the drive of the energy machines EM1, EM2, EM3 in combination with a corresponding actuation (opening and closing) of the clutches KI to K4 allows the speed and torque of the two output shafts 40, 42 to be varied to a large extent. However, the amount of components and installation space required for the transmission assembly 30 remains minor.

The terminology used herein is for the purpose of describing example embodiments or implementations and is not intended to be limiting of the disclosure. As used herein, the singular forms “a,” “an,” and “the” are intended to include the plural forms as well, unless the context clearly indicates otherwise. It will be further understood that the any use of the terms “has,” “includes,” “comprises,” or the like, in this specification, identifies the presence of stated features, integers, steps, operations, elements, and/or components, but does not preclude the presence or addition of one or more other features, integers, steps, operations, elements, components, and/or groups thereof.

Those having ordinary skill in the art will recognize that terms such as “above,” “below,” “upward,” “downward,” “top,” “bottom,” etc., are used descriptively for the drawings, and do not represent limitations on the scope of the present disclosure, as defined by the appended claims. Furthermore, the teachings may be described herein in terms of functional and/or logical block components or various processing steps, which may include any number of hardware, software, and/or firmware components configured to perform the specified functions.

Terms of degree, such as “generally,” “substantially,” or “approximately” are understood by those having ordinary skill in the art to refer to reasonable ranges outside of a given value or orientation, for example, general tolerances or positional relationships associated with manufacturing, assembly, and use of the described embodiments or implementations.

As used herein, “e.g.,” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

While the above describes example embodiments or implementations of the present disclosure, these descriptions should not be viewed in a restrictive or limiting sense. Rather, there are several variations and modifications which may be made without departing from the scope of the appended claims.

What is claimed is:

1. A transmission assembly for a drivetrain of an agricultural tractive unit, comprising:
an input shaft;
a first output shaft for a traction drive;
a second output shaft for a PTO drive; and
a first energy machine operatively connected to the input shaft via a branching stage, such that the power of the first energy machine is able to be transmitted to at least one coupled energy machine operatively connectable selectively to one or more of the first output shaft or the second output shaft via one or more clutches of a gear shift stage.

2. The transmission assembly of claim 1, wherein the at least one coupled energy machine includes a first coupled energy machine and a second coupled energy machine operatively connectable selectively to at least one of the first output shaft or the second output shaft via the one or more clutches of the gear shift stage.

3. The transmission assembly of claim 1, wherein the branching stage includes one of a branching gear set, a branching planetary gear, or at least one clutch of the gear shift stage.

4. The transmission assembly claim 3, further comprising:
a summing stage disposed between the branching stage and the first output shaft, the summing stage merging drive output from the branching stage and drive output from the at least one coupled energy machine.

5. The transmission assembly of claim 4, wherein the summing stage includes one of a summing gear set, a summing planetary gear, or the at least one clutch of the gear shift stage.

6. The transmission assembly of claim 3, further comprising:
a drive output-transmitting stage gear set disposed between the branching planetary gear and the first energy machine.

7. The transmission assembly of claim 5, further comprising:
a drive output-transmitting stage gear set disposed between the summing planetary gear and a coupled energy machine.

8. The transmission assembly of claim 5, wherein the branching stage is operatively connected to the summing stage, such that one or more of:
a gear of the branching gear set is operatively connected to the summing planetary gear,
a sun gear of the branching planetary gear is operatively connected to the summing planetary gear,
a planetary carrier shaft of the branching planetary gear is operatively connected to a ring gear shaft of the summing planetary gear, or
a sun gear of the branching planetary gear is operatively connected to a gear of the summing gear set.

9. The transmission assembly of claim 5, wherein the summing stage is operatively connected to at least one clutch of the gear switching stage, such that one or more of:
the branching planetary gear is operatively connected to an output side of the at least one clutch of the gear shift stage, or
the summing planetary gear is operatively connected to an output side of the at least one clutch of the gear shift stage.

10. The transmission assembly of claim 5, wherein the input shaft is operatively connected to one or more of the branching gear set, the branching planetary gear, the summing planetary gear, or a drive or output side of at least one clutch of the gear shift stage.

11. The transmission assembly of claim 5, wherein the first output shaft is operatively connected to one or more of a gear of a summing gear set, the summing planetary gear, the branching planetary gear, or a drive or output side of at least one clutch of the gear shift stage.

12. The transmission assembly of claim 1, wherein the at least one coupled energy machine includes a first coupled energy machine connected to the first output shaft for the traction drive and a second coupled energy machine connected to the second output shaft for the PTO drive.

13. The transmission assembly of claim 12, wherein the second coupled energy machine is connected to the first and second output shaft if a rotating speed of the first coupled energy machine is greater than the rotating speed threshold value.

14. The transmission assembly of claim 1, wherein the at least one coupled energy machine is operatively connected to the first output shaft via the summing stage.

15. The transmission assembly of claim 1, wherein one or more of the first energy machine or the at least one coupled energy machine is designed as an electric machine or as a hydraulic machine.

16. The transmission assembly of claim 1, further comprising:
at least one energy accumulator which is connected to one or more of the first energy machine and the at least one coupled energy machine.

17. The transmission assembly of claim 1, wherein the input shaft of the transmission assembly is connectable to an internal combustion engine of the agricultural tractive unit.
